(19) United States
(12) Patent Application Publication
(10) Pub. No.: US 2025/0076561 A1
(43) Pub. Date: Mar. 6, 2025

(54) LIGHT GUIDE ASSEMBLY AND ELECTRONIC DEVICE

(71) Applicant: Wistron NeWeb Corporation, Hsinchu (TW)

(72) Inventors: Yong Jyun LU, Hsinchu (TW); Jing Wen CHEN, Hsinchu (TW); Chang Yu HUANG, Hsinchu (TW); Ming-Hung HUNG, Hsinchu (TW); Yen Pin LIU, Hsinchu (TW)

(21) Appl. No.: 18/822,543

(22) Filed: Sep. 3, 2024

(30) Foreign Application Priority Data
Sep. 5, 2023 (TW) 112133610

(51) Int. Cl. F21V 8/00; G02B 1/04; G02B 5/00

(52) U.S. Cl. CPC G02B 6/0036; G02B 1/045; G02B 5/003; G02B 6/0031; G02B 6/0073

(57) ABSTRACT

A light guide assembly includes a housing element, at least one light guide element, and at least one light-shielding element. The housing element includes an outer surface and an inner surface. The light guide element is configured for a light to pass therethrough. The light guide element includes a light entrance surface, at least one light exit surface, and at least one wall surface. The wall surface surrounds and is connected to an edge of the light exit surface and extends toward the light entrance surface. The light exit surface is in contact with the inner surface. The at least one light-shielding element surrounds the at least one wall surface and is in contact with the inner surface.

### RELATED APPLICATIONS

This application claims the benefit of priority to Taiwan Patent Application Serial No. 112133610, filed on Sep. 5, 2023. The entire content of the above identified application is incorporated herein by reference.

### BACKGROUND

### Technical Field

The present disclosure relates to a light guide assembly and an electronic device, and more particularly, to a light guide assembly and an electronic device with a housing element.

### Description of Related Art

Driven by the pursuit of convenient living, various electronic devices have been developed, and indicator lights are often designed on electronic devices to show operating status. Furthermore, in response to the current trend of simplicity design, indicator lights by way of illumination through the electronic device casing are gradually emerging. That is, until the light source inside the electronic device is turned on, the user will not see the indicator lights on the casing, but when the light source is turned on, light will pass through the casing, thus achieving a simple appearance design. However, illuminated indicator lights often cannot be clearly displayed or recognized due to their high design complexity.

In view of this, the development of an electronic device and an assembly thereof that are able to clearly display indicator lights by way of illumination is in dire need for the market.

### SUMMARY

According to one aspect of the present disclosure, a light guide assembly includes a housing element, at least one light guide element, and at least one light-shielding element. The housing element includes an outer surface and an inner surface. The at least one light guide element is configured for a light to pass therethrough and includes a light entrance surface, at least one light exit surface, and at least one wall surface. The at least one light exit surface is in contact with the inner surface. The at least one wall surface surrounds and is connected to an edge of the at least one light exit surface and extends toward the light entrance surface. The at least one light-shielding element surrounds the at least one wall surface and is in contact with the inner surface.

According to another aspect of the present disclosure, an electronic device includes a housing element, at least one light guide element, and at least one light-emitting element. The housing element includes an outer surface, an inner surface, and at least one light transmissive portion. The at least one light guide element is configured for a light to pass therethrough and includes a light entrance surface, at least one light exit surface, and at least one wall surface. The at least one light exit surface corresponds to and is in contact with a part of the inner surface where the light transmissive portion is located. The at least one wall surface surrounds and is connected to an edge of the light exit surface and extends toward the light entrance surface. The at least one light-emitting element is configured for providing the light and disposed adjacent to the light entrance surface.

### BRIEF DESCRIPTION OF THE DRAWINGS

The present disclosure can be more fully understood by reading the following detailed description of the embodiment, with reference made to the accompanying drawings as follows:

FIG. 1A is a three-dimensional view of a light guide assembly according to a first embodiment of the present disclosure.

FIG. 1B is an exploded view of the light guide assembly shown in FIG. 1A.

FIG. 2A is an exploded view of an electronic device according to a second embodiment of the present disclosure.

FIG. 2B is a front view of the electronic device shown in FIG. 2A.

FIG. 2C is a sectional view illustrating section 20-2C of FIG. 2B.

FIG. 2D is a sectional view illustrating section 2D-2D of FIG. 2B.

FIG. 2E is a sectional view illustrating section 2E-2E of FIG. 2B.

FIG. 2F is a schematic view illustrating relative positions of light-emitting elements and light exit surfaces in the electronic device shown in FIG. 2A.

### DETAILED DESCRIPTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

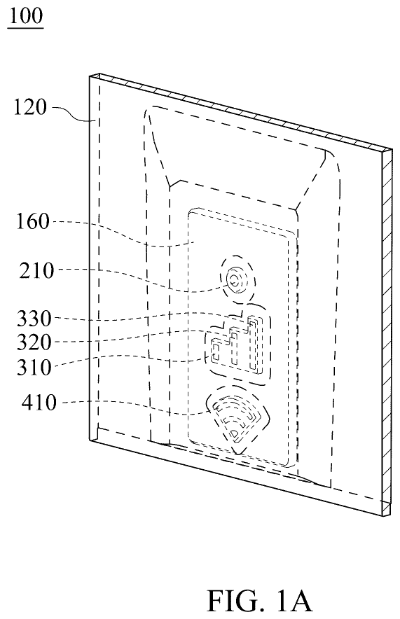

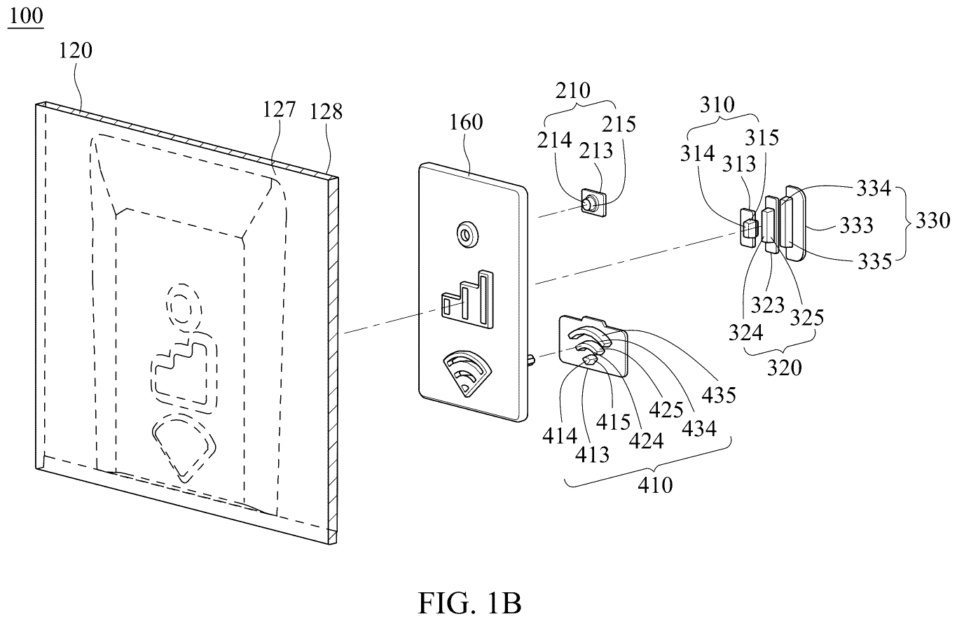

FIG. 1A is a three-dimensional view of a light guide assembly 100 according to a first embodiment of the present disclosure, and FIG. 1B is an exploded view of the light guide assembly 100 shown in FIG. 1A. Referring to FIGS. 1A and 1B, the light guide assembly 100 includes a housing element 120 and a light guide element 210. The housing element 120 is shell-shaped and includes an outer surface 127 and an inner surface 128. The light guide element 210 is configured for a light to pass therethrough and includes a light entrance surface 213, a light exit surface 214, and a wall surface 215. The wall surface 215 surrounds and is connected to the edge of the light exit surface 214 and extends toward the light entrance surface 213. The light exit surface 214 is in contact with the inner surface 128 of the housing element 120. This helps the outer surface 127 of the housing element 120 to display a sharp light transmitting pattern corresponding to the light exit surface 214.

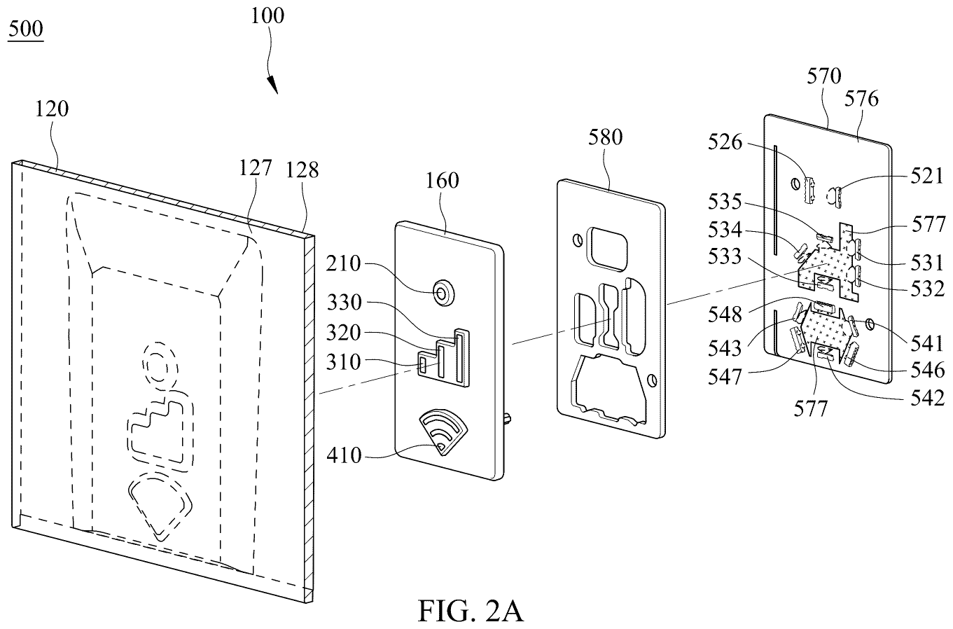

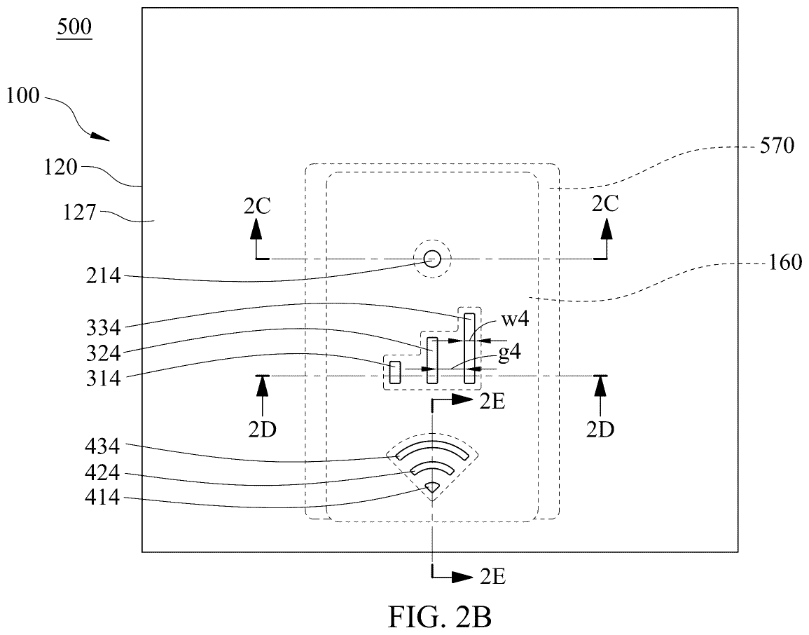

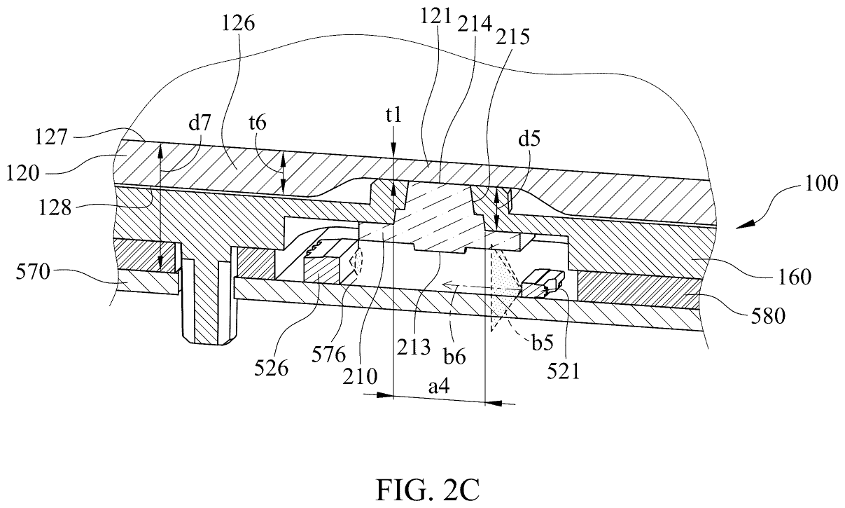

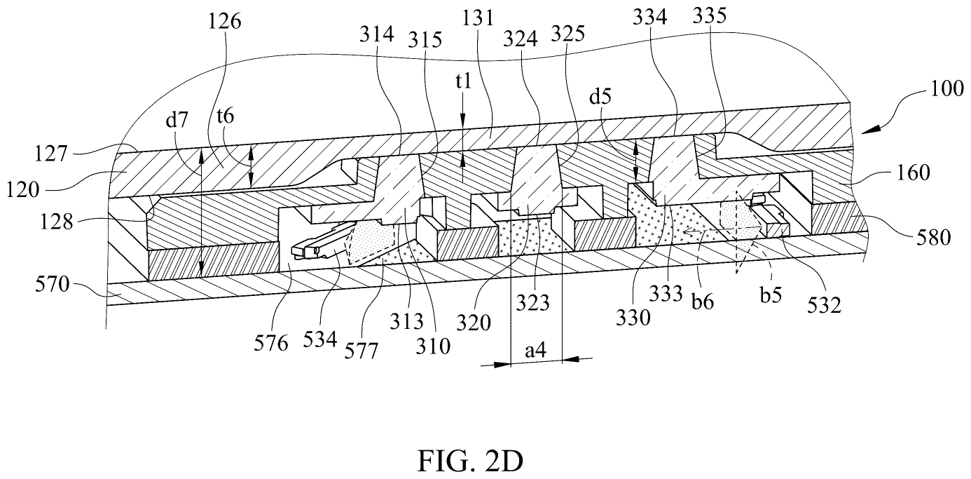

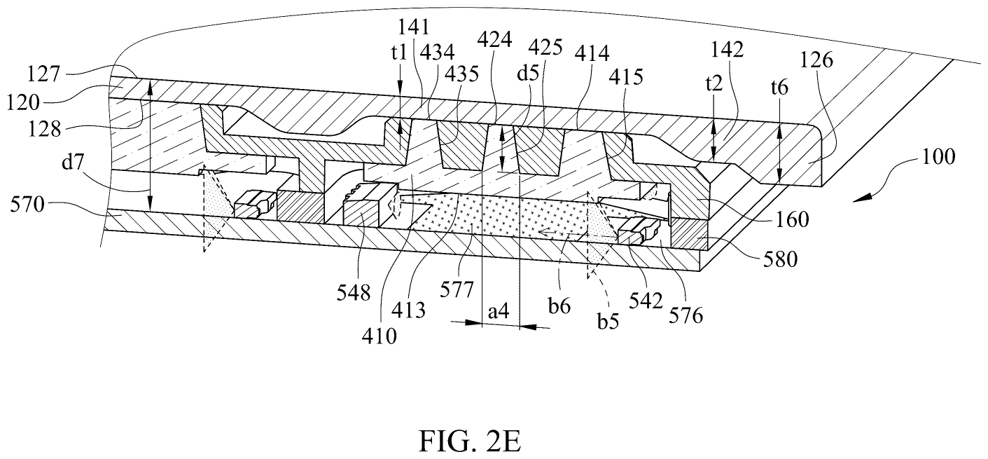

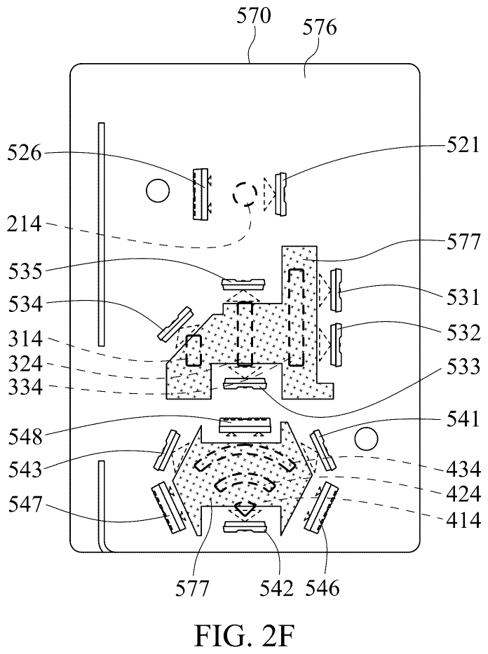

FIG. 2A is an exploded view of an electronic device 500 according to a second embodiment of the present disclosure, FIG. 2B is a front view of the electronic device 500 shown in FIG. 2A, and FIG. 2C is a sectional view illustrating section 2C-2C of FIG. 2B. Referring to FIGS. 2A to 2C, the electronic device 500 includes the housing element 120, the light guide element 210, and light-emitting elements 521, 526. In other words, the electronic device 500 of the second embodiment specifically includes the light guide assembly 100 of the first embodiment. The housing element 120 includes the outer surface 127, the inner surface 128, and a light transmissive portion 121. The light guide element 210 is used to allow a light b5 to pass therethrough and includes the light entrance surface 213, the light exit surface 214, and the wall surface 215. The wall surface 215 surrounds and is connected to the edge of the light exit surface 214 and extends toward the light entrance surface 213. The light exit surface 214 corresponds to and is in contact with the part of the inner surface 128 where the light transmissive portion 121 is located at. The light-emitting element 521, 526 is configured to provide the light b5 and is disposed adjacent to the light entrance surface 213. This helps the appearance of the electronic device 500 to have a sharp light transmitting pattern at the position corresponding to the light exit surface 214. Additionally, the electronic device 500 may further include a processor and a memory to control the light-emitting element 521, 526, but is not limited thereto.

Specifically, as shown in FIGS. 2B and 20, the circular light transmitting pattern indicating the power-on state of the electronic device 500 can be displayed on the part of the outer surface 127 where the light transmissive portion 121 is located at, and the circular light transmitting pattern corresponds to the light exit surface 214.

Referring to FIGS. 2A and 2C, the electronic device 500 and its light guide assembly 100 may further include at least one light-shielding element 160, which surrounds and is connected to the wall surface 215 of the light guide element 210 and is in contact with the inner surface 128. This avoids the need for additional processes such as coating (spraying/printing/IMF/IMD) on transparent housings, which are usually made of plastic material and have lower refractivity and less scattering, to achieve sharp and bright illumination effects (especially polygonal patterns with corners), which increase costs and resource consumption, making it difficult to balance appearance, cost, and environmental considerations. According to the present disclosure, the light guide assembly 100 can achieve sharp illumination effects without the need for appearance coating processes. Additionally, the light guide assembly according to the present disclosure may include a single light-shielding element or multiple light-shielding elements that are either separate or assembled together.

The entire light exit surface 214 can be in direct contact with the inner surface 128, with no air gap between a entirety of the light exit surface 214 and the inner surface 128 (practically, the air gap is between 0 um and 100 um). This avoids the phenomenon of refraction or scattering that occurs when light enters the medium of the housing element from the air layer in the conventional technology, thereby preventing the edges of the light transmitting pattern from becoming blurred and failing to present a sharp effect. Additionally, there is no air gap between the part of the light-shielding element 160 that surrounds and is connected to the edge of the light exit surface 214 and the inner surface 128. However, considering process tolerances, other parts of the light-shielding element 160 may have small air gaps with the inner surface 128 to ensure that there is no air gap between the light exit surface 214 and the inner surface 128.

The light guide element 210 can be made of a light transmissive or transparent plastic material, and the light-shielding element 160 can be made of an opaque plastic material. This allows for a high degree of freedom in plastic injection molding, enabling the light exit surface 214 to extend outward and abut against the light transmissive portion 121 of the plastic housing element 120, and reducing refraction and scattering caused by the air layer during the transmission of the light b5 to the housing element 120. This achieves a design with no air gap, minimizing the impact of refraction and scattering. The thin plastic light transmissive portion 121 is designed with the mold, and so a sharper light transmitting pattern can be achieved. Specifically, the light guide element 210 can be made of a transparent plastic material. Additionally, the light-shielding element 160 can be made of an opaque plastic, rubber, silicone, or silicone resin material, such as a black plastic or black flexible light-shielding material, but is not limited thereto.

Referring to FIG. 2C, the housing element 120 may further include a main portion 126. The thickness t1 of the light transmissive portion 121 is less than the thickness t6 of the main portion 126, and the light exit surface 214 of the light guide element 210 corresponds to and is in contact with the part of the inner surface 128 where the light transmissive portion 121 is located at. This effectively utilizes the thin plastic light-transmitting characteristics of the housing element 120 formed by plastic molding.

The direction of the wall depth d5 of the wall surface 215 is defined as a direction parallel to the normal direction of the inner surface 128. The ratio of the wall depth d5 of the wall surface 215 to the thickness t1 of the light transmissive portion 121 can be between 1.5 and 8. This ensures light guide efficiency within the short depth constraints in the space. Furthermore, the ratio of the wall depth d5 of the wall surface 215 to the thickness t1 of the light transmissive portion 121 can be between 2 and 4. Specifically, the wall depth d5 of the wall surface 215 is 1.55 mm, the thickness t1 of the light transmissive portion 121 is 0.7 mm, and the ratio of the wall depth d5 to the thickness t1 is 2.2.

The aperture a4 (or cross-sectional area) surrounded by the wall surface 215 can gradually increase in a direction from the light exit surface 214 toward the light entrance surface 213. This facilitates the inward light entrance surface 213 to be closer to the light-emitting surfaces of the light-emitting elements 521, 526, obtaining the maximum amount of incoming light while enabling the outward light exit surface 214 to produce the desired light-transmitting characteristics for the light transmitting pattern.

Referring to FIGS. 2A and 2C, the electronic device 500 may further include a circuit board 570, which is disposed inside the housing element 120. The light-emitting elements 521, 526 are disposed on the surface 576 of the circuit board 570 facing the housing element 120.

The central light-emitting direction b6 of each of the light-emitting elements 521, 526 can be parallel to the surface 576 of the circuit board 570 (i.e., perpendicular to the normal direction of the surface 576), and a portion with at least half of the area of the light entrance surface 213 is parallel to the surface 576 of the circuit board 570. This achieves a larger amount of incoming light while saving costs and device space.

FIG. 2F is a schematic view illustrating relative positions of the light-emitting elements 521, 526, 531, 532, 533, 534, 535, 541, 542, 543, 546, 547, 548, and the light exit surfaces 214, 314, 324, 334, 414, 424, 434 in the electronic device 500 shown in FIG. 2A. Referring to FIGS. 2C and 2F, each of the light-emitting elements 521, 526 can be a light-emitting diode (LED) element, and the light-emitting elements 521, 526 are arranged to surround the light entrance surface 213 and the light exit surface 214. This means that the LED light-emitting elements 521, 526 adopt a side-emitting type and are placed at both two ends of the light guide element 210. In the electronic device according to the present disclosure, multiple light-emitting elements can be disposed at both two ends, left and right sides, diagonal angles, or around the light guide element to obtain a more uniform light-transmitting effect. Additionally, the light-emitting element can also be a LED module that includes at least two LEDs, such as the light-emitting element 526.

FIG. 2D is a sectional view illustrating section 2D-2D in FIG. 2B. Referring to FIGS. 2A, 2B, and 2D, the electronic device 500 and its light guide assembly 100 further include three light guide elements (i.e., light guide elements 310, 320, 330), all made of transparent plastic material and used to allow light b5 to pass therethrough. The light guide element 310 includes a light entrance surface 313, a light exit surface 314, and a wall surface 315. The light guide element 320 includes a light entrance surface 323, a light exit surface 324, and a wall surface 325. The light guide element 330 includes a light entrance surface 333, a light exit surface 334, and a wall surface 335. The housing element 120 further includes a light transmissive portion 131. The light exit surfaces 314, 324, 334 correspond to and are in contact with the part of the inner surface 128 where the light transmissive portion 131 is located at.

The electronic device 500 further includes five light-emitting elements (i.e., light-emitting elements 531, 532, 533, 534, 535), all used to provide light b5 and disposed on the surface 576 of the circuit board 570 facing the housing element 120. The distance d7 between the outer surface 127 of the housing element 120 and the surface 576 of the circuit board 570 can be less than or equal to 20 mm, and the thickness t1 of the light transmissive portion 131 can be between 0.4 mm and 3.0 mm (or between 0.4 mm and 1.0 mm). This allows the electronic device 500 according to the present disclosure to achieve sharp light-transmitting effects for polygons with inner corner angles less than 130 degrees and light transmitting patterns with widths w4 less than 2 mm or spacings g4 less than 2 mm, within the constraints of the distance d7 in a very short internal space, as shown in FIG. 2B. Additionally, the distance d7 can be less than or equal to 15 mm. In the second embodiment, the distance d7 is 4.25 mm, and the thickness t1 is 0.7 mm.

As shown in FIGS. 2B and 2D, the three rectangular light transmitting patterns indicating the received signal strength of the mobile communication network of the electronic device 500 can be displayed on the part of the outer surface 127 where the light transmissive portion 131 is located at, with the three rectangular light transmitting patterns corresponding to the light exit surfaces 314, 324, 334. The electronic device 500 can sharply present polygonal light-transmitting patterns with corners.

Referring to FIGS. 2A and 2D, the light-shielding element 160 surrounds and is connected to the wall surfaces 315, 325, 335 of the light guide elements 310, 320, 330, respectively, and is in contact with the inner surface 128. The light-shielding element 160 isolates (separates) the adjacent wall surfaces 315, 325 and isolates the adjacent wall surfaces 325, 335. Each of the entire light exit surfaces 314, 324, 334 is in direct contact with the inner surface 128, with no air gap between each of the entire light exit surfaces 314, 324, 334 and the inner surface 128. Additionally, there is no air gap between the part of the light-shielding element 160 surrounding and being connected to the edges of each of the light exit surfaces 314, 324, 334 and the inner surface 128.

The electronic device 500 may further include at least one elastic element 580, connected between the light-shielding element 160 and the circuit board 570. This helps to enhance the sealing property around the light exit surfaces 314, 324, 334 and improves assembling convenience.

Additionally, the light-emitting element 534 is disposed adjacent to the light entrance surface 313, the light-emitting elements 533, 535 are disposed adjacent to the light entrance surface 323, and the light-emitting elements 531, 532 are disposed adjacent to the light entrance surface 333. The elastic element 580 can be made of an opaque flexible/soft elastic material (e.g., a black foam material). The light-shielding element 160 and the elastic element 580 shield and isolate the adjacent light guide elements 310, 320 and shield and isolate the adjacent light guide elements 320, 330. This allows the design concept of the light guide elements 310, 320, 330 and their related components to be applied to small areas and gaps that require independent light transmission for multiple light transmitting patterns.

Referring to FIGS. 2D and 2F, the central light-emitting direction b6 of each of the light-emitting elements 531, 532, 533, 534, 535 is parallel to the surface 576 of the circuit board 570, and a portion with at least half of the area of each of the light entrance surfaces 313, 323, 333 is parallel to the surface 576 of the circuit board 570. Each of the light-emitting elements 531, 532, 533, 534, 535 is a light-emitting diode (LED) element, and the light-emitting elements 533, 535 are arranged to surround the light entrance surface 323 and the light exit surface 324.

The surface 576 of the circuit board 570 includes a reflective area 577 with a reflective layer, and the reflective area 577 is configured to allow at least a portion of the light b5 to be reflected via the reflective area 577 to be incident on the light entrance surfaces 313, 323, 333 of the light guide elements 310, 320, 330, respectively. The reflective layer of the reflective area 577 can be made of printed white paint, and it increases the amount of incoming light through reflection by the printed white paint, achieving a more uniform light-transmitting effect even at very short light-transmitting distances (the distance d7).

FIG. 2E is a sectional view illustrating section 2E-2E of FIG. 2B. Referring to FIGS. 2B and 2E, the electronic device 500 and its light guide assembly 100 further include a light guide element 410, made of a transparent plastic material and used to allow light b5 to pass therethrough.

Referring to FIG. 2A, the light guide elements 210, 310, 320, 330, 410, and the light-shielding element 160 can be integrally formed and manufactured by a double (dual) injection molding method. For example, the light guide elements 210, 310, 320, 330, 410 made of transparent material can be formed by the first injection, and the light-shielding element 160 made of opaque material can be formed by the second injection, but not limited thereto. Utilizing the freedom and flexibility provided by double injection molding, complex and sharp polygonal patterns can be molded with transparent plastic material (with a diffuser), and the light-shielding element 160 made of black plastic material can form a light-blocking wall structure within the transparent light guide elements 210, 310, 320, 330, 410 in the same time, preventing light leakage which affects the light-transmitting result. Combined with the elastic element 580 made of light-blocking flexible material, the light-blocking and anti-leakage effects can be further enhanced. Additionally, the light guide elements and light-shielding elements according to the present disclosure can also be formed by assembling.

Referring to FIGS. 2A, 2B, and 2E, the light guide element 410 includes a light entrance surface 413, light exit surfaces 414, 424, 434, and wall surfaces 415, 425, 435. Therefore, the number of light exit surfaces and wall surfaces of the light guide element 410 are both three. The light-shielding element 160 isolates the adjacent wall surfaces 415, 425 and isolates the adjacent wall surfaces 425, 435. The housing element 120 further includes a light transmissive portion 141, with the light exit surfaces 414, 424, 434 corresponding to and being in contact with the part of the inner surface 128 where the light transmissive portion 141 is located. This allows for simplified design of patterns that are separated but need to be lit simultaneously, achieving sharp light transmitting pattern effects with the light-shielding element 160.

Additionally, the light guide element 410 is used to transmit the light b5 from the single/same light entrance surface 413 to the light exit surfaces 414, 424, 434. This reduces design complexity for separated but simultaneously lit light transmitting patterns.

The electronic device 500 further includes six light-emitting elements (i.e., light-emitting elements 541, 542, 543, 546, 547, 548), all used to provide light b5 and disposed on the surface 576 of the circuit board 570 facing the housing element 120.

As shown in FIGS. 2B and 2E, the three arc-shaped light transmitting patterns indicating the connection of the electronic device 500 to a wireless network can be displayed on the part of the outer surface 127 where the light transmissive portion 141 is located, with the three arc-shaped light transmitting patterns corresponding to the light exit surfaces 414, 424, 434. The electronic device 500 can sharply present the light transmitting patterns having angles and arcs.

Referring to FIGS. 2A and 2E, the light-shielding element 160 surrounds and is connected to the wall surfaces 415, 425, 435 of the light guide element 410, and is in contact with the inner surface 128. The light-shielding element 160 isolates the adjacent wall surfaces 415, 425 and isolates the adjacent wall surfaces 425, 435. Each of the light exit surfaces 414, 424, 434 directly contacts with the inner surface 128, with no air gap between each of the entire light exit surfaces 414, 424, 434 and the inner surface 128. Additionally, there is no air gap between the part of the light-shielding element 160 surrounding and being connected to the edges of each of the light exit surfaces 414, 424, 434 and the inner surface 128.

Referring to FIG. 2E, the housing element 120 may further include a transition portion 142. The light exit surfaces 414, 424, 434 of the light guide element 410 correspond to and contact with the part of the inner surface 128 located at the light transmissive portion 141. The transition portion 142 is connected between the light transmissive portion 141 and the main portion 126, with the thickness t2 of the transition portion 142 being greater than the thickness t1 of the light transmissive portion 141 and less than the thickness t6 of the main portion 126. A two-stage thickness reduction method is used for the housing element 120. For example, the thickness t6 of the main portion 126 can be between 2.5 mm and 2.2 mm, first reduced by half to the thickness t2 of the transition portion 142, which can be between 1.3 mm and 1.1 mm, and then further reduced by half to the target thin thickness of the light transmissive portion 141, which can be between 0.7 mm and 0.6 mm. This maintains molding pressure and reduces drastic thickness changes while reducing thickness, alleviating molding stress marks to achieve a better molded appearance.

Referring to FIGS. 2E and 2F, the central light-emitting direction b6 of each of the light-emitting elements 541, 542, 543, 546, 547, 548 is parallel to the surface 576 of the circuit board 570, and a portion with at least half of the area of the light entrance surface 413 is parallel to the surface 576 of the circuit board 570. Each of the light-emitting elements 541, 542, 543, 546, 547, 548 is a light-emitting diode (LED) element, with the light-emitting elements 541, 542, 543, 546, 547, 548 arranged to surround the light entrance surface 413 and the light exit surfaces 414, 424, 434. The reflective area 577 of the circuit board 570 is used to reflect at least a portion of the light b5 via the reflective area 577 to be incident on the light entrance surface 413 of the light guide element 410.

Additionally, each of the light-emitting elements 541, 542, 543 emits white light, and the light-emitting elements 546, 547, 548 emit red, green, and blue light, respectively; or each of the light-emitting elements 546, 547, 548 emits white light, and the light-emitting elements 541, 542, 543 emit red, green, and blue light, respectively. This enhances the flexibility of component selection and provides a refined aesthetic appearance.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A light guide assembly, comprising:
a housing element comprising an outer surface and an inner surface;
at least one light guide element configured for a light to pass therethrough and comprising:
a light entrance surface;
at least one light exit surface in contact with the inner surface; and
at least one wall surface surrounding and being connected to an edge of the at least one light exit surface and extending toward the light entrance surface; and
at least one light-shielding element surrounding the at least one wall surface and being in contact with the inner surface.

2. The light guide assembly according to claim 1, wherein the light exit surface is entirely in direct contact with the inner surface, and there is no air gap between a entirety of the light exit surface and the inner surface.

3. The light guide assembly according to claim 1, wherein the housing element further comprises at least one light transmissive portion and a main portion, a thickness of the light transmissive portion is less than a thickness of the main portion, and the light exit surface of the light guide element corresponds to and is in contact with a part of the inner surface where the light transmissive portion is located.

4. The light guide assembly according to claim 3, wherein the housing element further comprises at least one transition portion connected between the light transmissive portion and the main portion, and a thickness of the transition portion is greater than the thickness of the light transmissive portion and less than the thickness of the main portion.

5. The light guide assembly according to claim 3, wherein a direction of a wall depth of the wall surface is parallel to a normal direction of the inner surface, and a ratio of the wall depth of the wall surface to the thickness of the light transmissive portion is between 1.5 and 8.

6. The light guide assembly according to claim 1, wherein the at least one light-shielding element surrounds and is connected to the at least one wall surface.

7. The light guide assembly according to claim 1, wherein the light guide element is made of a transparent plastic material, the light-shielding element is made of an opaque plastic material, and the light guide element and the light-shielding element are integrally formed by a double injection molding method.

8. The light guide assembly according to claim 1, wherein a number of the at least one light exit surface and a number of the at least one wall surface of the light guide element are plural and equal, each of the plurality of wall surfaces surrounds and is connected to the edge of a corresponding one of the plurality of light exit surfaces and extends toward the light entrance surface, and the at least one light-shielding element isolates two adjacent ones of the plurality of wall surfaces.

9. The light guide assembly according to claim 8, wherein the light guide element is configured for the light to be transmitted from the light entrance surface to the plurality of light exit surfaces.

10. The light guide assembly according to claim 1, wherein an aperture surrounded by the wall surface gradually increases in a direction from the light exit surface toward the light entrance surface.

11. An electronic device, comprising:
a housing element comprising an outer surface, an inner surface, and at least one light transmissive portion;
at least one light guide element configured for a light to pass therethrough and comprising:
a light entrance surface;
at least one light exit surface corresponding to and being in contact with a part of the inner surface where the light transmissive portion is located; and
at least one wall surface surrounding and being connected to an edge of the light exit surface and extending toward the light entrance surface; and
at least one light-emitting element configured for providing the light and disposed adjacent to the light entrance surface.

12. The electronic device according to claim 11, further comprising:
a circuit board, wherein the at least one light-emitting element is disposed on a surface of the circuit board that faces the housing element, a distance between the outer surface of the housing element and the surface of the circuit board is less than or equal to 20 mm, and a thickness of the light transmissive portion is between 0.4 mm and 3.0 mm.

13. The electronic device according to claim 12, wherein a central light-emitting direction of the light-emitting element is parallel to the surface of the circuit board, and a portion with at least half of an area of the light entrance surface is parallel to the surface of the circuit board.

14. The electronic device according to claim 12, wherein the surface of the circuit board comprises a reflective area with a reflective layer, and the reflective area is configured to allow at least a portion of the light to be reflected via the reflective area to be incident on the light entrance surface of the light guide element.

15. The electronic device according to claim 12, further comprising:
at least one light-shielding element surrounding and being connected to the at least one wall surface and being in contact with the inner surface.

16. The electronic device according to claim 15, further comprising:
at least one elastic element connected between the at least one light-shielding element and the circuit board.

17. The electronic device according to claim 16, wherein a number of the at least one light guide element is plural, a number of the at least one light-emitting element is plural, at least one of the plurality of light-emitting elements is disposed adjacent to the light entrance surface of each of the plurality of light guide elements;
wherein the at least one light-shielding element is made of an opaque plastic material, the at least one elastic element is made of an opaque flexible elastic material, and the at least one light-shielding element and the at least one elastic element shield and isolate two adjacent ones of the light guide elements.

18. The electronic device according to claim 11, wherein a number of the at least one light exit surface and a number of the at least one wall surface of the light guide element are plural and equal, each of the plurality of wall surfaces surrounds and is connected to the edge of a corresponding one of the plurality of light exit surfaces and extends toward the light entrance surface, a number of the at least one light-emitting element is plural, and the plurality of light-emitting elements are arranged to surround the plurality of light exit surfaces.

19. The electronic device according to claim 18, wherein each of the plurality of light-emitting elements is a light-emitting diode element, the number of light-emitting elements is at least three, and the at least three light-emitting elements respectively emit a red light, a green light, and a blue light.

20. The electronic device according to claim 11, wherein a light transmitting pattern is displayed on a part of the outer surface where the light transmissive portion is located, and the light transmitting pattern corresponds to the light exit surface.
